(19) United States
(12) Patent Application Publication
(10) Pub. No.: US 2014/0308393 A1
(43) Pub. Date: Oct. 16, 2014

(54) REDUCED CALORIE INFANT FORMULAS CONTAINING SPECIFIC WHEY TO CASEIN RATIOS

(71) Applicant: ABBOTT LABORATORIES, ABBOTT PARK, IL (US)

(72) Inventors: Barbara J. Marriage, Columbus, OH (US); Christine L. Gallardo, New Albany, OH (US)

(73) Assignee: ABBOTT LABORATORIES, ABBOTT PARK, IL (US)

(21) Appl. No.: 14/364,115

(22) PCT Filed: Dec. 14, 2012
(86) PCT No.: PCT/US12/69615

§ 371 Date: Jun. 10, 2014

Related U.S. Application Data
(60) Provisional application No. 61/580,477, filed on Dec. 27, 2011.

(51) Int. Cl. A23L 1/29; A23L 1/305

(52) U.S. Cl. CPC A23L 1/296; A23L 1/3056
USPC 426/2; 426/583

(57) ABSTRACT

The present disclosure is directed to nutrition systems including at least a first and a second reduced calorie infant formula having varying whey to casein protein weight ratios for reducing inflammation-related diseases later in life. Particularly, the nutrition systems may be administered to a newborn infant to reduce the risk of obesity later in life.

### CROSS REFERENCE TO RELATED APPLICATIONS

The present application hereby claims the benefit of the provisional patent application Ser. No. 61/580,477, filed Dec. 27, 2011, the disclosure of which is hereby incorporated by reference in its entirety.

### FIELD OF THE DISCLOSURE

The present disclosure is directed to the use of nutrition systems including at least first and second infant formulas that have differing whey protein to casein protein weight ratios for reducing long term adverse health effects, including obesity, later in life. The first and the second infant formulas are low calorie and optionally low protein infant formulas, and are administered to an infant in sequential fashion such that the first formula has a higher whey protein to casein protein weight ratio as compared to the second infant formula.

### BACKGROUND OF THE DISCLOSURE

The inflammatory response is an attempt by the body to restore and maintain homeostasis after invasion by an infectious agent, antigen challenge, or physical, chemical or traumatic damage. While the inflammatory response is generally considered a healthy response to injury, the immune system can present an undesirable physiological response if it is not appropriately regulated. Specifically, unregulated oxidation and associated inflammation are major causes of tissue damage and clinically significant disease in preterm and term infants. This is due in large part to the immaturity in function of the natural immune system of infants, and especially preterm infants.

Inflammation is one of the leading mechanisms of non-communicable diseases in the world, in particular, obesity and its co-morbidities. For example, obesity is characterized by chronic low-grade inflammation in adipose tissue which contributes to insulin resistance, type 2 diabetes (non-insulin dependent diabetes mellitus), and cardiovascular disease. Cytokine secreted by cells of the innate immune system (i.e., macrophages) and adipose tissues (e.g., adipokines) are believed to be the key to regulating the inflammatory milieu. In particular, IL-1β, TNF-α, and activation of the NF-κB pathway have been linked to the negative metabolic effects of obesity, including cardiovascular disease and type 2 diabetes. Furthermore, inhibition of several independent arms of the NF-κB pathway shows less weight gain, increased insulin sensitivity, improved lipid profile, and decreases inflammation.

Breastfeeding has been associated with enhanced development and balanced growth and maturation of the infant's immune systems, thereby providing protection of the infant to infection and inflammatory-related diseases. Breast milk appears to contain antioxidants, such as superoxide dismutase, glutathione peroxidase and catalase, or other non-enzymatic antioxidants such as glutathione, lactoferrin and polyphenols, in addition to antioxidants, such as vitamins A, C, E and selenium.

Not all infants receive human breast milk. Further, no vaccines are currently available for the prevention of inflammatory-related diseases, such as obesity and insulin resistance. Therefore, development of safe and efficacious preventative or therapeutic methods would be beneficial, especially for infants. Particularly, infant formulas designed to be closer to breast milk in terms of composition and function would provide a benefit to these infants.

It would therefore be desirable to provide an infant formula or system of infant formulas that could reduce the risk of inflammatory-related diseases, such as obesity, later in life.

### SUMMARY OF THE DISCLOSURE

The present disclosure is directed to the use of a nutrition system including at least first and second reduced calorie infant formulas that have differing whey protein to casein protein weight ratios for reducing the risk of inflammatory-related diseases later in life. The reduced calorie infant formulas are sequentially administered during the first two weeks of life to provide nutrition to the infant and begin to program the long term health of the infant. The first infant formula administered to the infant has a higher whey protein to casein protein weight ratio than does the second infant formula administered to the infant. The reduced calorie formulas of the present disclosure, when sequentially administered to infants during the first two weeks of life, reduce the risk of inflammatory-related diseases, such as obesity and insulin resistance, later in life.

Thus, in one embodiment, the present disclosure is directed to a method of reducing obesity later in life. The method comprises administering to an infant in need thereof during the first two weeks of life a first infant formula followed by a second infant formula. The first infant formula has a higher whey to casein protein weight ratio than the second infant formula. Each of the first and second infant formulas has an energy content of less than 650 Kcal/L.

In another embodiment, the present disclosure is directed to a method of reducing obesity later in life. The method comprises administering to an infant in need thereof a first infant formula and second infant formula. Both the first and second infant formulas have an energy content of less than 650 Kcal/L. The first infant formula is administered for the first 1 to 10 days of the infant's life and the second infant formula is administered for a period of 4 to 13 days such that the first and second infant formulas are administered for a total of no more than 14 days. The first infant formula has a higher whey to casein protein weight ratio than the second infant formula.

In another embodiment, the present disclosure is directed to a method of reducing inflammatory-related diseases later in life. The method comprises administering to an infant in need thereof during the first two weeks of life a first infant formula followed by a second infant formula. The first infant formula has a higher whey to casein protein weight ratio than the second infant formula. Each of the first and second infant formulas has an energy content of less than 650 Kcal/L.

In another embodiment, the present disclosure is directed to a nutrition system comprising a first infant formula and a second infant formula. The first infant formula has a higher whey to casein protein weight ratio than the second infant formula. Each of the first and second infant formulas has an energy content of less than 600 Kcal/L.

It has now surprisingly been discovered that nutrition systems including at least first and second reduced calorie infant formulas having varying whey protein to casein protein weight ratios may be utilized to reduce inflammatory-related diseases later in life, and in particular obesity later in life. These reduced calorie infant formulas, when utilized in a sequential manner early in life, program the infant to reduce long term adverse health effects by potentially reducing impacting one or more inflammatory markers.

It has also been discovered that the nutrition system of reduced calorie liquid or powder infant formulas having varying whey to casein protein weight ratios can reduce the risk of insulin resistance, non-insulin dependent diabetes mellitus, cardiovascular disease, and atherosclerosis later in life.

### DETAILED DESCRIPTION OF THE DISCLOSURE

The nutrition systems of the present disclosure include at least first and second reduced calorie infant formulas. The first reduced calorie infant formulas have a higher whey protein to casein protein weight ratio than do the second reduced calorie infant formulas of the nutrition system. These first and second formulas may be used sequentially during the first two weeks of an infant's life to reduce long term adverse health effects, including obesity later in life. The nutrition systems described herein include at least two infant formulas having differing whey protein to casein protein weight ratios and may, in some embodiments, include three, four, or even more infant formulas having differing whey protein to casein protein weight ratios.

The nutritional systems of the present disclosure, which in some embodiments include low protein infant formulas, provide a simple and effective means for reducing the incidence of long term adverse health effects in an infant including, for example, obesity and cardiovascular disease later in life.

The nutritional system infant formulas provide the required nutritional benefits for growth and maturation to the infant, while providing the infant with the additional significant advantage of decreasing the incidence of long term adverse health effects, many of which continue to afflict more and more teenagers and adults every day. These benefits, as well as other benefits as described herein are, advantageously, provided to the infant without any type of dietary change or specific dietary requirement. The infant formulas as described herein can provide infants with dependable, high quality nutrition, as well as program the infant early in life such that the infant has a head start to a healthy body shape and improved general overall health later in life. The infant formulas as described herein provide the infant with nutritional benefits early in life that transcend into significant health benefits later in life allowing the infant to potentially lead a longer, healthier life as a teenager and adult.

These and other optional features of the nutrition systems and methods of the present disclosure, as well as some of the many other optional variations and additions, are described in detail hereafter.

The terms “retort” and “retort sterilized” are used interchangeably herein, and unless otherwise specified, refer to the common practice of filling a container, most typically a metal can or other similar package, with a nutritional liquid, such as a liquid infant formula, and then subjecting the liquid-filled package to the necessary heat sterilization step, to form a retort sterilized nutritional liquid product.

The terms “aseptic” and “aseptic sterilized” are used interchangeably herein, and unless otherwise specified, refer to the manufacture of a packaged product without reliance upon the above-described retort packaging step, wherein the nutritional liquid and package are sterilized separately prior to filling, and then are combined under sterilized or aseptic processing conditions to form a sterilized, aseptically packaged, nutritional liquid product.

The terms “nutritional formula” or “nutritional product” or “nutritional composition,” as used herein, are used interchangeably and, unless otherwise specified, refer to nutritional liquids, nutritional solids, nutritional semi-liquids, nutritional semi-solids, nutritional powders, nutritional supplements, and any other nutritional food product as known in the art. The nutritional powders may be reconstituted to form a nutritional liquid, all of which comprise one or more of fat, protein and carbohydrate, and are suitable for oral consumption by a human. Nutritional formulas may include infant formulas.

The term “nutritional liquid,” as used herein, unless otherwise specified, refers to nutritional products in ready-to-drink liquid form, concentrated form, and nutritional liquids made by reconstituting the nutritional powders described herein prior to use.

The term “nutritional powder,” as used herein, unless otherwise specified, refers to nutritional products in flowable or scoopable form that can be reconstituted with water or another aqueous liquid prior to consumption and includes both spray dried and drymixed/dryblended powders.

The term “nutritional semi-solid,” as used herein, unless otherwise specified, refers to nutritional products that are intermediate in properties, such as rigidity, between solids and liquids. Some semi-solids examples include puddings, gelatins, and doughs.

The term “nutritional semi-liquid,” as used herein, unless otherwise specified, refers to nutritional products that are intermediate in properties, such as flow properties, between liquids and solids. Some semi-liquids examples include thick shakes and liquid gels.

The term “nutrition system” as used herein, unless otherwise specified, refers to the combination of two or more nutritional formulas that are intended to be administered to an infant in a specific sequential fashion as described herein.

The term “infant,” as used herein, unless otherwise specified, refers to a child 12 months or younger. The term “preterm infant,” as used herein, refers to an infant born prior to 36 weeks of gestation. The term “term infant,” as used herein, refers to an infant born at or after 36 weeks of gestation.

The term “newborn infant,” as used herein, unless otherwise specified, refers to infants less than about 3 months of age, including infants from zero to about 2 weeks of age. The newborn infant may be a term or preterm infant.

The term “infant formula,” as used herein, unless otherwise specified, refers to liquid and solid nutritional products suitable for consumption by an infant. Unless otherwise specified herein, the term “infant formula” is intended to encompass both term and preterm infant formulas.

The term “preterm infant formula,” as used herein, unless otherwise specified, refers to liquid and solid nutritional products suitable for consumption by a preterm infant.

The term “full calorie infant formula,” as used herein, refers to an infant formula in which the caloric density or energy content of the formula has not been reduced from that conventionally included in infant formula. Typically, a full calorie infant formula will have an energy content of at least 650 kcal/L, including at least 660 kcal/L, and more typically at least 676 kcal/L, including 650 kcal/L to 800 kcal/L.

The terms “reduced calorie infant formula” or “low calorie infant formula,” as used herein, are used interchangeably to refer to an infant formula that has a lower energy content, on a per volume basis, than a full calorie infant formula.

The term “later in life,” as used herein, refers to the period of life from adolescence through adulthood.

The terms “susceptible to,” and “at risk of,” as used herein, are used interchangeably to refer to individuals having little resistance to a certain condition or disease, including being genetically predisposed, having a family history of, and/or having symptoms of the condition or disease

The terms “inflammatory disease,” “inflammatory-related disease,” or “inflammatory condition” as used herein, unless otherwise specified, refer to any disease, disorder, or condition characterized by inflammation.

All percentages, parts and ratios as used herein, are by weight of the total composition, unless otherwise specified. All such weights, as they pertain to listed ingredients, are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the infant formulas of the nutrition systems of the present disclosure may also be substantially free of any optional or selected essential ingredient or feature described herein, provided that the remaining infant formulas still contain all of the required ingredients or features as described herein. In this context, and unless otherwise specified, the term “substantially free” means that the selected infant formulas contain less than a functional amount of the optional ingredient, typically less than 1%, including less than 0.5%, including less than 0.1%, and also including zero percent, by weight of such optional or selected essential ingredient.

The infant formulas used in the nutrition systems and methods of the present disclosure may comprise, consist of, or consist essentially of the essential elements of the products and methods as described herein, as well as any additional or optional element described herein or otherwise useful in nutritional infant formula applications.

### Nutrition System Product Form

The nutrition systems of the present disclosure include at least two infant formulas and, in some embodiments, will include at least three or at least four or more infant formulas, each of which includes a different weight ratio of whey protein to casein protein. As described more fully herein, the infant formulas that make up the nutrition systems of the present disclosure are administered to the infant sequentially such that the first infant formula has a set whey protein to casein protein weight ratio, and each subsequent infant formula administered to the infant has a weight ratio of whey protein to casein protein that is less than the infant formula previously administered such that as the infant ages, the infant receives a progressively lower amount of whey protein. By way of specific example, in one embodiment, a first infant formula having a whey protein to casein protein weight ratio of 90:10 is administered to an infant for a desired period of time followed by the administration of a second infant formula having a whey protein to casein protein weight ratio of 80:20 for a desired period of time such that the second infant formula has a whey protein to casein protein weight ratio that is less than the first infant formula. In another example, a third infant formula having a weight ratio of whey protein to casein protein of 70:30 is administered for a desired period of time after the administration of the second infant formula such that the third infant formula has a lower whey protein to casein protein weight ratio that the previous infant formula administered.

The infant formulas for use in the nutrition systems of the present disclosure may be formulated and administered in any known or otherwise suitable oral product form. Any solid, liquid, semi-solid, semi-liquid, or powder form, including combinations or variations thereof, are suitable for use herein, provided that such forms allow for safe and effective oral delivery to the individual of the essential ingredients as also defined herein.

Specific non-limiting examples of product forms suitable for use with products and methods disclosed herein include, for example, liquid and powder preterm infant formulas, liquid and powder term infant formulas, and liquid and powder elemental and semi-elemental formulas.

The infant formulas used in the nutrition systems of the present disclosure are desirably formulated as dietary product forms, which are defined herein as those embodiments comprising the essential ingredients of the present disclosure in a product form that then contains at least one of fat, protein, and carbohydrate.

The infant formulas may be formulated with sufficient kinds and amounts of nutrients to provide a sole, primary, or supplemental source of nutrition, or to provide a specialized nutritional product for use in infants afflicted with specific diseases or conditions or with a targeted nutritional benefit.

The infant formulas of the present disclosure may be formulated for both term and preterm infants. Desirably, the infant formulas utilized in the nutrition systems are formulated for feeding to infants within the first few days, weeks or months following birth, and include for feeding to infants from age zero to one year, including from age zero to six months, including from age zero to two months, including from age zero to one month, including from age zero up to 14 days, including day 1 to 13 days following birth, including day 4 to 13 days following birth, and including day 1 to 10 days following birth. In one particularly desirable embodiment, the infant is fed from birth to an age of 14 days with the nutritional system as described herein, wherein the first infant formulas is fed for the first seven days and the second infant formula is fed for the second 7 days. In another particularly desirable embodiment, the infant is fed from birth to an age of 14 days with the nutritional system as described herein, wherein the first infant formulas is fed for the first 10 days and the second infant formula is fed for the second 4 days.

In some embodiments a first infant formula is for feeding to infants during a period of 1 day to 10 days, including 1 day to 9 days, including 1 day to 8 days, including 1 day to 7 days, including 1 day to 6 days, including 1 day to 5 days, including 1 day to 4 days, including 1 day to 3 days, including 1 day to 2 days, and including 1 day, and a second infant formula is for feeding to newborn infants during a period of 1 day to 10 days, including 1 day to 9 days, including 1 day to 8 days, including 1 day to 7 days, including 1 day to 6 days, including 1 day to 5 days, including 1 day to 4 days, including 1 day to 3 days, including 1 day to 2 days, and including 1 day, wherein the first infant formula and the second infant formula are administered for a total of no more than 14 days. In one particular embodiment, the first infant formula is administered to the infant for a period of 1 day to 10 days, and the second infant formula is administered to the infant for a period of 1 day to 10 days, wherein the first infant formula and the second infant formula are administered for a total of no more than 14 days. In another embodiment, the first infant formula is administered to the infant for a period of 1 day to 10 days, and the second infant formula is administered to the infant for a period of 4 day to 13 days, wherein the first infant formula and the second infant formula are administered for a total of no more than 14 days. It is to be understood that the administration of the infant formulas of the present disclosure is not limited to administration during only the first six months following birth, but may be administered to older infants as well.

### Nutritional Liquids

Nutritional liquids include both concentrated and ready-to-feed nutritional liquids. These nutritional liquids are most typically formulated as suspensions, emulsions or clear or substantially clear liquids.

Nutritional emulsions suitable for use in the nutrition systems may be aqueous emulsions comprising proteins, fats, and carbohydrates. These emulsions are generally flowable or drinkable liquids at from about 1° C. to about 25° C. and are typically in the form of oil-in-water, water-in-oil, or complex aqueous emulsions, although such emulsions are most typically in the form of oil-in-water emulsions having a continuous aqueous phase and a discontinuous oil phase.

The nutritional liquids may be and typically are shelf stable. The nutritional liquids typically contain up to about 95% by weight of water, including from about 50% to about 95%, also including from about 60% to about 90%, and also including from about 70% to about 85%, of water by weight of the nutritional liquid.

The nutritional liquids may have a variety of product densities, but most typically have a density about 1.01 g/mL or higher, including greater than about 1.02 g/mL, including greater than about 1.03 g/mL, including greater than about 1.04 g/mL, including greater than about 1.055 g/mL, including from about 1.06 g/mL to about 1.12 g/mL, and also including from about 1.085 g/mL to about 1.10 g/mL.

The nutritional liquids may have a pH ranging from about 3.5 to about 8, but are most advantageously in a range of from about 4.5 to about 7.5, including from about 4.5 to about 7.0, including from about 4.5 to about 6.5, including from about 4.5 to about 6.0. In other embodiments, the pH range may be from about 5.5 to about 7.3, including from about 5.5 to about 7.0, including from about 5.5 to about 6.5, including from about 6.2 to about 7.2, including from about 6.2 to about 7.0, and including from about 6.2 to about 6.5.

Although the serving size for the nutritional liquid can vary depending upon a number of variables, a typical serving size is generally at least about 2 mL, or even at least about 5 mL, or even at least about 10 mL, or even at least about 25 mL, including ranges from about 2 mL to about 300 mL, including from about 100 mL to about 300 mL, from about 4 mL to about 250 mL, from about 150 mL to about 250 mL, from about 10 mL to about 240 mL, and from about 190 mL to about 240 mL.

### Nutritional Powders

The nutritional powders for use in the nutrition systems are in the form of flowable or substantially flowable particulate compositions, or at least particulate compositions. Particularly suitable nutritional powder forms include spray dried, agglomerated or dryblended powder compositions, or combinations thereof, or powders prepared by other suitable methods. The compositions can easily be scooped and measured with a spoon or similar other device, wherein the compositions can easily be reconstituted with a suitable aqueous liquid, typically water, to form a nutritional liquid, such as an infant formula, for immediate oral or enteral use. In this context, “immediate” use generally means within about 48 hours, most typically within about 24 hours, preferably right after or within 20 minutes of reconstitution.

### Energy Content of Infant Formula

The infant formulas of the nutrition systems of the present disclosure have a reduced energy content (used herein interchangeably with the term “caloric density”) relative to conventional term and preterm infant formulas. The reduced energy content may, in some embodiments, be achieved by reducing the level of one or more macronutrients in the formula. Specifically, the infant formulas of the present disclosure provide a caloric density or energy content of less than 650 Kcal/L, including less than 600 Kcal/L, including from about 200 Kcal/L to less than 650 Kcal/L, including from about 200 Kcal/L to about 600 Kcal/L, including from about 200 Kcal/L to less than 600 Kcal/L, and more particularly from about 250 Kcal/L to about 500 Kcal/L. In some embodiments, the caloric density may be between about 250 kcal/L and about 450 kcal/L, or even from about 250 kcal/L and about 400 kcal/L, or even from about 250 kcal/L to about 300 kcal/L. In contrast to the infant formulas of the nutrition systems of the present disclosure, the caloric density or energy content of conventional term and preterm infant formulas, which are also referred to herein as “full calorie infant formulas,” is significantly higher, typically ranging from 650 kcal/L to 880 kcal/L.

When the infant formulas of the nutrition systems of the present disclosure are in powder form, then the powder is intended for reconstitution prior to use to obtain the above-noted caloric densities and other nutrient requirements. Likewise, when the infant formulas are in a concentrated liquid form, then the concentrate is intended for dilution prior to use to obtain the requisite caloric densities and nutrient requirements. The infant formulas can also be formulated as ready-to-feed liquids already having the requisite caloric densities and nutrient requirements.

The infant formulas of the nutrition systems of the present disclosure are desirably administered to infants, and in particular newborn infants, in accordance with the methods described herein. Such methods may include feedings with the infant formulas in accordance with the daily formula intake volumes described herein.

The energy component of the infant formulas is most typically provided by a combination of fat, protein, and carbohydrate nutrients. In some embodiments, the protein may comprise from about 4% to about 40% of the total calories, including from about 10% to about 30%, also including from about 15% to about 25%; the carbohydrate may comprise less than 50% of the total calories, including from about 5% to about 45%, also including less than about 42%, and also including from about 20% to about 37%; and the fat may comprise the remainder of the formula calories, most typically less than about 60% of the calories, including from about 30% to about 60%. Other exemplary amounts or protein, carbohydrate, and fat are set forth hereinafter for use in alternative embodiments.

### Macronutrients

The infant formulas used in the nutrition systems of the present disclosure comprise carbohydrate, fat, and protein macronutrients of sufficient types and amounts to meet the nutritional needs of the infant. The concentration of these macronutrients in the various embodiments of the present disclosure includes the ranges described hereinafter.

### Protein

The reduced calorie infant formulas for use in the nutrition systems of the present disclosure comprise a protein suitable for use in infant formulas. In some embodiments the infant formulas of the present disclosure include reduced amounts of protein as compared to conventional term and preterm infant formulas. For example, the reduced protein infant formulas include protein in an amount of less than 14.0 grams protein per liter of formula, including from about 5.0 to about 10.0 grams protein per liter of formula, and including from about 7.6 to about 10.0 grams protein per liter of formula.

One embodiment of the present disclosure relates to the use of two or more reduced calorie infant formulas, which comprise the requisite protein concentrations with a specific blend of casein protein and whey protein. The protein blend includes whey to casein in a protein weight ratio of 90:10, including a ratio of 85:15, including a ratio of 80:20, including a ratio of 75:25, including a ratio of 70:30, including a ratio of 65:35, and including a ratio of 60:40. It has been found that these particular blends of whey protein and casein protein provide for a nutrition system that can be administered to an infant in the first two weeks of life to reduce the risk of inflammatory-related diseases, and in particular, obesity, later in life. As described herein, when a system of two reduced calorie infant formulas is used, the first infant formula administered to the infant has a higher whey to casein protein weight ratio than the second infant formula; stated another way, as the infant becomes older, the infant is given an infant formula that includes whey to casein in a protein weight ratio that is less than the whey to casein protein weight ratio initially given to the infant. In one particularly preferred embodiment, a first infant formula having a whey to casein weight ratio of 90:10 is fed to the infant from birth to 7 days old and a second infant formula having a whey to casein weight ratio of 70:30 is fed to the infant for days 8 to 14.

In some embodiments, the nutrition systems of the present disclosure include a first infant formula having a first whey to casein protein weight ratio and a second infant formula having a second whey to casein protein weight ratio, wherein the first infant formula's whey to casein protein weight ratio is higher than the second infant formula's whey to casein protein weight ratio. In one particular embodiment, the first infant formula has a whey to casein protein weight ratio of 90:10 and the second infant formula has a whey to casein protein weight ratio of 60:40.

In some embodiments, in addition to the whey protein and casein protein outlined above, the infant formulas for use in the nutrition systems may contain additional protein. Suitable additional protein may include soy protein hydrolysate, casein protein hydrolysate, whey protein hydrolysate, rice protein hydrolysate, potato protein hydrolysate, fish protein hydrolysate, egg albumen hydrolysate, gelatin protein hydrolysate, combinations of animal and vegetable protein hydrolysates, and combinations thereof.

In this context, the terms “protein hydrolysates” or “hydrolyzed protein” are used interchangeably herein and include extensively hydrolyzed proteins, wherein the degree of hydrolysis is most often at least about 20%, including from about 20% to about 80%, and also including from about 30% to about 80%, even more preferably from about 40% to about 60%. The degree of hydrolysis is the extent to which peptide bonds are broken by a hydrolysis method. The degree of protein hydrolysis for purposes of characterizing the extensively hydrolyzed protein component of these embodiments is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

Depending upon the selected embodiment of the present disclosure, the proteins suitable for use in the infant formulas may therefore include intact or hydrolyzed proteins, free amino acids, or combinations thereof. Non-limiting examples of suitable proteins include hydrolyzed, partially hydrolyzed or non-hydrolyzed protein, and can be derived from any known or otherwise suitable source such as milk (e.g., casein, whey, lactose-free milk protein isolates), animal (e.g., meat, fish), cereal (e.g., rice, corn), vegetable (e.g., soy), or combinations thereof. The additional protein can include, or be entirely or partially replaced by, free amino acids known or otherwise suitable for use in nutritional products, non-limiting examples of which include L-alanine, L-arginine, L-asparagine, L-aspartic acid, L-carnitine, L-cystine, L-glutamic acid, L-glutamine, glycine, L-histidine, L-isoleucine, L-leucine, L-lysine, L-methionine, L-phenylalanine, L-proline, L-serine, L-taurine, L-threonine, L-tryptophan, L-tyrosine, L-valine, and combinations thereof.

### Fat

The infant formulas of the nutrition systems may comprise a source or sources of fat in addition to the blend of casein and whey protein described herein. Suitable sources of fat for use in the infant formulas disclosed herein include any fat or fat source that is suitable for use in an oral nutritional product and is compatible with the essential elements and features of such products, provided that such fats are suitable for feeding to infants.

Non-limiting examples of suitable fats or sources thereof for use in the infant formulas described herein include coconut oil, fractionated coconut oil, soybean oil, corn oil, olive oil, safflower oil, high oleic safflower oil, high GLA-safflower oil, oleic acids, MCT oil (medium chain triglycerides), sunflower oil, high oleic sunflower oil, structured triglycerides, palm and palm kernel oils, palm olein, canola oil, flaxseed oil, borage oil, evening primrose oil, blackcurrant seed oil, transgenic oil sources, marine oils (e.g., tuna, sardine), fish oils, fungal oils, algae oils, cottonseed oils, and combinations thereof. In one embodiment, suitable fats or sources thereof include oils and oil blends including long chain polyunsaturated fatty acids (LC-PUFAs). Some non-limiting specific polyunsaturated acids for inclusion include, for example, docosahexaenoic acid (DHA), arachidonic acid (ARA), eicosapentaenoic acid (EPA), linoleic acid (LA), and the like. Non-limiting sources of arachidonic acid and docosahexaenoic acid include marine oil, egg derived oils, fungal oil, algal oil, and combinations thereof. Particularly preferred fat sources include high oleic safflower oil, soy oil, and coconut oils, which may all be used in combination with ARA and/or DHA oil. In one preferred embodiment, the infant formula included a combination of high oleic safflower oil, soy oil, and coconut oil, in combination with ARA oil and DHA oil.

### Carbohydrate

The infant formulas of the nutrition systems may comprise any carbohydrates that are suitable for use in an oral nutritional product, such as an infant formula, and are compatible with the essential elements and features of such product.

Non-limiting examples of suitable carbohydrates or sources thereof for use in the infant formulas described herein may include maltodextrin, hydrolyzed, intact, or modified starch or cornstarch, glucose polymers, corn syrup, corn syrup solids, rice-derived carbohydrates, rice syrup, pea-derived carbohydrates, potato-derived carbohydrates, tapioca, sucrose, glucose, fructose, lactose, high fructose corn syrup, honey, sugar alcohols (e.g., maltitol, erythritol, sorbitol), artificial sweeteners (e.g., sucralose, acesulfame potassium, stevia), indigestible oligosaccharides such as fructooligosaccharides (FOS), and combinations thereof. In one embodiment, the carbohydrate may include a maltodextrin having a DE value of less than 20.

Although total concentrations or amounts of the protein, fat, and carbohydrate in the infant formulas may vary depending upon the product form (e.g., powder or ready-to-feed liquid) and targeted dietary needs of the intended user, such concentrations or amounts most typically fall within one of the embodied ranges described in the following table (each numerical value is preceded by the term “about”), inclusive of any other essential fat, protein, and or carbohydrate ingredients as described herein. For powder embodiments, the amounts in the following Table A are amounts following reconstitution of the powder.

TABLE A

| Nutrient (g/100 mL) | Example A | Example B |
|---|---|---|
| Protein | 0.5 to 1.5 | 0.6 to 0.9 |
| Fat | 1.2 to 2.5 | 1.4 to 2.3 |
| Carbohydrate | 2.7 to 6.5 | 3.1 to 6.1 |

The level or amount of carbohydrate, fat, and protein in the infant formula (whether a powder formula or a liquid ready-to-feed or concentrated liquid) may also be characterized in addition to or in the alternative as a percentage of total calories in the infant formulas. These macronutrients for infant formulas used in the nutrition systems of the present disclosure are most typically formulated within any of the caloric ranges described in the following Table B (each numerical value is preceded by the term “about”).

TABLE B

| Nutrient (% total calories) | Example C | Example D | Example E |
|---|---|---|---|
| Carbohydrate | 2 to 96 | 10 to 75 | 30 to 50 |
| Protein | 2 to 96 | 5 to 70 | 15 to 35 |
| Fat | 2 to 96 | 20 to 85 | 35 to 55 |
| | Example F | Example G | Example H |
| Carbohydrate | 25 to 50 | 25 to 50 | 35 to 50 |
| Protein | 10 to 30 | 5 to 30 | 7.5 to 25 |
| Fat | 1 to 20 | 2 to 20 | 30 to 55 |

### Other Optional Ingredients

The infant formulas of the nutrition systems of the present disclosure may further comprise other optional ingredients that may modify the physical, chemical, aesthetic or processing characteristics of the products or serve as pharmaceutical or additional nutritional components when used in the targeted population. Many such optional ingredients are known or otherwise suitable for use in medical food or other nutritional products or pharmaceutical dosage forms and may also be used in the compositions herein, provided that such optional ingredients are safe for oral administration and are compatible with the essential and other ingredients in the selected product form.

Non-limiting examples of such optional ingredients include preservatives, anti-oxidants, emulsifying agents, buffers, fructooligosaccharides, galactooligosaccharides, human milk oligosaccharides and other prebiotics, probiotics, nucleotides, carotenoids, pharmaceutical actives, additional nutrients as described herein, colorants, flavors, thickening agents and stabilizers, emulsifying agents, lubricants, and so forth, and combinations thereof.

A flowing agent or anti-caking agent may be included in the powder infant formulas as described herein to retard clumping or caking of the powder over time and to make a powder embodiment flow easily from its container. Any known flowing or anti-caking agents that are known or otherwise suitable for use in a nutritional powder or product form are suitable for use herein, non limiting examples of which include tricalcium phosphate, silicates, and combinations thereof. The concentration of the flowing agent or anti-caking agent in the nutritional product varies depending upon the product form, the other selected ingredients, the desired flow properties, and so forth, but most typically range from about 0.1% to about 4%, including from about 0.5% to about 2%, by weight of the composition.

A stabilizer may also be included in the infant formulas. Any stabilizer that is known or otherwise suitable for use in a nutritional product is also suitable for use herein, some non-limiting examples of which include gums such as xanthan gum. The stabilizer may represent from about 0.1% to about 5.0%, including from about 0.5% to about 3%, including from about 0.7% to about 1.5%, by weight of the infant formula.

The infant formulas may further comprise any of a variety of vitamins, non-limiting examples of which include vitamin A, vitamin D, vitamin E, vitamin K, thiamine, riboflavin, pyridoxine, vitamin B 12, niacin, folic acid, pantothenic acid, biotin, vitamin C, choline, inositol, salts and derivatives thereof, and combinations thereof.

The infant formulas may also further comprise any of a variety of minerals known or otherwise suitable for use in infant or other nutritional formulas, non-limiting examples of which include phosphorus, magnesium, calcium as described hereinbefore, zinc, manganese, copper, iodine, sodium, potassium, chloride, selenium, and combinations thereof.

### Methods of Manufacture

The infant formulas for use in the nutrition systems of the present disclosure may be prepared by any known or otherwise effective manufacturing technique for preparing the selected product solid or liquid form. Many such techniques are known for any given product form such as nutritional liquids or powders and can easily be applied by one of ordinary skill in the art to the infant formulas described herein.

The infant formulas can therefore be prepared by any of a variety of known or otherwise effective formulation or manufacturing methods. In one suitable manufacturing process, for example, at least two separate slurries are prepared, that are later blended together, heat treated, standardized, and either terminally sterilized to farm a retort infant formula or aseptically processed and filled to form an aseptic infant formula. Alternately, the slurries can be blended together, heat treated, standardized, heat treated a second time, evaporated to remove water, and spray dried to form a powder infant formula.

The slurries formed may include a carbohydrate-mineral (CHO-MIN) slurry and a protein-in-fat (PIF) slurry. Initially, the CHO-MIN slurry is formed by dissolving selected carbohydrates (e.g., lactose, galactooligosaccharides, etc.) in heated water with agitation, followed by the addition of minerals (e.g., potassium citrate, magnesium chloride, potassium chloride, sodium chloride, choline chloride, etc.). The resulting CHO-MIN slurry is held with continued heat and moderate agitation until it is later blended with the other prepared slurries.

The PIF slurry is formed by heating and mixing the oil (e.g., high oleic safflower oil, soybean oil, coconut oil, monoglycerides, etc.) and emulsifier (e.g., soy lecithin), and then adding oil soluble vitamins, mixed carotenoids, protein (e.g., whey protein, casein protein, etc.), carrageenan (if any), calcium carbonate or tricalcium phosphate (if any), and ARA oil and DHA oil (in some embodiments) with continued heat and agitation. The resulting PIF slurry is held with continued heat and moderate agitation until it is later blended with the other prepared slurries.

Water was heated and then combined with the CHO-MIN slurry, nonfat milk (if any), and the PIF slurry under adequate agitation. The pH of the resulting blend was adjusted to 6.6-7.0, and the blend was held under moderate heated agitation. ARA oil and DHA oil is added at this stage in some embodiments.

The composition is then subjected to high-temperature short-time (HTST) processing, during which the composition is heat treated, emulsified and homogenized, and then cooled. Water soluble vitamins and ascorbic acid are added, the pH is adjusted to the desired range if necessary, flavors (if any) are added, and water is added to achieve the desired total solid level. For aseptic infant formulas, the emulsion receives a second heat treatment through an aseptic processor, is cooled, and then aseptically packaged into suitable containers. For retort infant formulas, the emulsion is packaged into suitable containers and terminally sterilized. In some embodiments, the emulsions can be optionally further diluted, heat-treated, and packaged to form a desired ready-to-feed or concentrated liquid, or can be heat-treated and subsequently processed and packaged as a reconstitutable powder, e.g., spray dried, dry mixed, agglomerated.

The spray dried powder infant formula or dry-mixed powder infant formula may be prepared by any collection of known or otherwise effective techniques, suitable for making and formulating a nutritional powder. For example, when the powder infant formula is a spray-dried nutritional powder, the spray drying step may likewise include any spray drying technique that is known for or otherwise suitable for use in the production of nutritional powders. Many different spray drying methods and techniques are known for use in the nutrition field, all of which are suitable for use in the manufacture of the spray dried powder infant formulas herein. Following drying, the finished powder may be packaged into suitable containers.

### Methods of Use

The nutrition systems described herein and including at least two reduced calorie infant formulas (which may optionally also be reduced protein infant formulas) having differing whey protein to casein protein weight ratios may be orally administered to infants, including term, preterm, and/or newborn infants. The reduced calorie infant formulas may be administered as a source of nutrition for infants and/or can be used to prevent and/or reduce and/or minimize and/or eliminate the development of one or more of the potentially inflammatory-related diseases or conditions later in life discussed herein. One subclass of the general infant population that can effectively utilize the nutrition systems described herein include those infants that are susceptible to, or at risk of, getting one or more of the diseases or conditions (is at elevated risk as compared to the general infant population for getting the disease or condition due to certain conditions including family history, etc.) described herein, including obesity, later in life. These infants who are susceptible to or at risk of getting the disease or condition may be referred to as “in need of” assistance (or “in need thereof” as referring to the assistance) in combating getting the disease or condition later in life. The methods of the present disclosure are particularly directed to infants that have a family history of the diseases and conditions set forth herein, and particularly a family history of obesity or diabetes or insulin control problems.

Based on the forgoing, because some of the method embodiments of the present disclosure are directed to specific subsets or subclasses of infants (that is, the subset or subclass of infants that are “in need” of assistance in addressing one or more specific diseases or specific conditions that they are susceptible to later in life), not all infants can benefit from all method embodiments described herein as not all infants will fall within the subset or subclass of infants as described herein for certain diseases or conditions.

The infant formulas of the nutrition systems will typically be administered daily, at intake volumes suitable for the age of the infant. For instance, in one embodiment, the methods of the present disclosure may include administering a first reduced calorie infant formula followed by a second reduced calorie infant formula to an infant at the average intake volumes described herein. In some embodiments, newborn infants are provided with increasing formula volumes during the initial weeks of life. Such volumes most typically range up to about 100 mL/day on average during the first day or so of life; up to about 200 to about 700 mL/day, including from about 200 to about 600 mL/day, and also including from about 250 to about 500 mL/day, on average during the remainder of the two week newborn feeding period. It is to be understood, however, that such volumes can vary considerably depending upon the particular newborn infant and their unique nutritional needs during the initial weeks of life, as well as the specific nutrients and caloric density of the infant formula administered.

In some embodiments, the methods of the present disclosure may be directed to infants during the initial days, or weeks of life. In a desirable embodiment, the first and second infant formulas having different whey to casein protein weight ratios are administered to a newborn infant for a total of 14 days. Desirably, a first reduced calorie infant formula described herein is administered to the infant for a duration of at least 1 day, more desirably during a period of 1 day to 10 days, followed by a second reduced calorie infant formula described herein to be administered to the infant for a duration of at least 1 day, more desirably during a period of 1 day to 10 days, and in some embodiments during a period of 4 days to 13 days. The first and second reduced calorie infant formulas are to be administered to the infant for a duration of at least the first week of life, more desirably during the first two weeks of life. Thereafter, the infant may be switched to a conventional infant formula, alone or in combination with human milk.

As noted above, the infant formulas used in the methods described herein, unless otherwise specified, are nutritional formulas and may be in any product form, including ready-to-feed liquids, concentrated liquids, reconstituted powders, and the like. In embodiments where the infant formulas are in powder form, the method may further comprise reconstituting the powder with an aqueous vehicle, most typically water or human milk, to form the desired caloric density, which is then orally or enterally fed to the infant. The powdered formulas are reconstituted with a sufficient quantity of water or other suitable fluid such as human milk to produce the desired caloric density, as well as the desired feeding volume suitable for one infant feeding. The infant formulas may also be sterilized prior to use through retort or aseptic means.

In one aspect, the present disclosure is directed to a method of providing nutrition to an infant. The method comprises administering to the infant a first infant formula followed by a second infant formula of the present disclosure. Such methods may include the daily administration of one of the infant formulas, including administration at the daily intake volumes as described hereinbefore. In some embodiments, the infant is a newborn infant.

In another aspect, the infant formulas can be administered to the infant as described herein to reduce one or more long term adverse health effects later in the life of the infant. Particularly, in some embodiments, the infant formulas can be administered in amounts such to decrease the expression of proinflammatory cytokines and to increase anti-inflammatory cytokines early in life and later in life. Further, administration of these formulas inhibits inflammatory pathways such as NF-κB and MAPK, thereby reducing inflammation. By reducing inflammation, which may be an underlying mechanism of inflammatory-related diseases and conditions, the risk of the infants getting the diseases later in life is reduced and possibly even prevented in some embodiments. The infant formulas of the present disclosure are intended to be utilized in some embodiments to reduce or eliminate later in life as discussed herein specific adverse health effects including obesity, type 2 diabetes, insulin resistance, non-insulin dependent diabetes mellitus, cardiovascular disease, and atherosclerosis.

### EXAMPLES

The following examples illustrate specific embodiments and/or features of the infant formulas used in the nutrition systems and methods of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the composition, unless otherwise specified.

Unless otherwise specified, the retort sterilized formulas prepared in accordance with the manufacturing methods described herein, are ready-to-feed liquid formulas.

### Examples 1-3

In these examples, 2 oz. retort sterilized first and second infant formulas were prepared with varying whey to casein protein weight ratios, wherein the first infant formula has a higher whey to casein protein weight ratio (90:10) than the second infant formulas (70:30 Second Infant Formula 1 and 60:40 Second Infant Formula 2). The ingredients used to prepare the formulas are set forth in Tables 1-3 below. The amounts of ingredients are amounts per 1000 kg batch.

TABLE 1

| | | First Infant |
|---|---|---|
| | Units | Formula 1 |
| Energy | Kcal/L | 270 |
| Ingredient Water | kg | Q.S. |
| Lactose | kg | 27.3 |
| Whey Protein Concentrate | kg | 6.60 |
| High Oleic Safflower Oil | kg | 5.43 |
| Galactooligosaccharides | kg | 4.40 |
| Soy Oil | kg | 4.06 |
| Coconut Oil | kg | 3.88 |
| Nonfat Dry Milk | kg | 2.06 |
| 1N KOH | kg | 1.06 |
| Potassium Hydroxide | g | 53.0 |
| Ultra Micronized Tricalcium Phosphate | g | 500.3 |
| Ascorbic Acid | g | 485.0 |
| ARA Oil | g | 363.0 |
| Nucleotide-Choline Premix | g | 328.5 |
| Choline Bitartrate | g | 57.98 |
| Cytidine 5′-Monophosphate | g | 34.16 |
| Disodium Guanosine 5′-Monophosphate | g | 17.52 |
| Disodium Uridine 5′-Monophosphate | g | 14.73 |
| Adenosine 5′-Monophosphate | g | 12.99 |
| Magnesium Chloride | g | 170.1 |
| Potassium Chloride | g | 147.0 |
| Soy Lecithin | g | 143.0 |
| Distilled Monoglycerides | g | 143.0 |
| DHA Oil | g | 138.2 |
| Carrageenan | g | 200.0 |
| Vit/Min/Taur Premix | g | 66.1 |
| Taurine | g | 20.21 |
| m-Inositol | g | 14.67 |
| Zinc Sulfate | g | 6.77 |
| Niacinamide | g | 4.31 |
| Calcium Pantothenate | g | 2.59 |
| Ferrous Sulfate | g | 2.26 |
| Cupric Sulfate | mg | 793.7 |
| Thiamine Chloride HCl | mg | 669.3 |
| Riboflavin | mg | 295.1 |
| Pyridoxine HCl | mg | 270.4 |
| Folic Acid | mg | 90.9 |
| Manganese Sulfate | mg | 77.0 |
| Biotin | mg | 26.1 |
| Sodium Selenate | mg | 15.7 |
| Cyanocobalamin | mg | 2.08 |
| Mixed Carotenoid Premix | g | 58.1 |
| Lycopene | mg | 121.2 |
| Lutein | mg | 121.2 |
| Beta-Carotene | mg | 26.3 |
| Ferrous Sulfate | g | 26.9 |
| Vitamin A, D3, E, K1 | g | 22.5 |
| RRR Alpha-Tocopheryl Acetate | g | 4.53 |
| Vitamin A Palmitate | mg | 851.4 |
| Vitamin K1 (Phylloquinone) | mg | 49.3 |
| Vitamin D3 | mg | 5.97 |
| Choline Chloride | g | 21.5 |
| Sodium Chloride | g | 18.0 |
| L-Carnitine | g | 1.87 |
| Potassium Citrate | g | 1.24 |
| Riboflavin | mg | 386 |
| Vitamin A Palmitate | mg | 310 |
| Thiamine Hydrochloride | mg | 220 |
| Calcium Citrate | | as needed |

TABLE 2

| | | Second Infant |
|---|---|---|
| | Units | Formula 1 |
| Energy | Kcal/L | 406 |
| Ingredient Water | kg | Q.S. |
| Lactose | kg | 39.7 |
| Nonfat Dry Milk | kg | 9.32 |
| Galactooligosaccharides | kg | 8.63 |
| High Oleic Safflower Oil | kg | 7.58 |
| Whey Protein Concentrate | kg | 6.80 |
| Soy Oil | kg | 5.68 |
| Coconut Oil | kg | 5.42 |
| 1N KOH | kg | 1.08 |
| Potassium Hydroxide | g | 54.0 |
| Ascorbic Acid | g | 497.1 |
| Ultra Micronized Tricalcium Phosphate | g | 445.0 |
| ARA Oil | g | 359.5 |
| Soy Lecithin | g | 309.0 |
| Distilled Monoglycerides | g | 309.0 |
| Nucleotide-Choline Premix | g | 306.4 |
| Choline Bitartrate | g | 54.1 |
| Cytidine 5′-Monophosphate | g | 31.9 |
| Disodium Guanosine 5′-Monophosphate | g | 16.3 |
| Disodium Uridine 5′-Monophosphate | g | 13.7 |
| Adenosine 5′-Monophosphate | g | 12.1 |
| Potassium Chloride | g | 184.6 |
| Carrageenan | g | 200.0 |
| Magnesium Chloride | g | 142.3 |
| DHA Oil | g | 136.9 |
| Calcium Citrate | g | 108.9 |
| Vit/Min/Taur Premix | g | 89.9 |
| Taurine | g | 27.5 |
| m-Inositol | g | 20.0 |
| Zinc Sulfate | g | 9.2 |
| Niacinamide | g | 5.9 |
| Calcium Pantothenate | g | 3.5 |
| Ferrous Sulfate | g | 3.1 |
| Cupric Sulfate | g | 1.1 |
| Thiamine Chloride HCl | mg | 910.2 |
| Riboflavin | mg | 401.4 |
| Pyridoxine HCl | mg | 367.7 |
| Folic Acid | mg | 123.6 |
| Manganese Sulfate | mg | 104.7 |
| Biotin | mg | 35.5 |
| Sodium Selenate | mg | 21.3 |
| Cyanocobalamin | mg | 2.8 |
| Mixed Carotenoid Premix | g | 57.7 |
| Lycopene | mg | 121.2 |
| Lutein | mg | 121.2 |
| Beta-Carotene | mg | 26.3 |
| Ferrous Sulfate | g | 35.3 |
| Vitamin A, D3, E, K1 | g | 33.1 |
| RRR Alpha-Tocopheryl Acetate | g | 6.69 |
| Vitamin A Palmitate | g | 1.26 |
| Vitamin K1 (Phylloquinone) | mg | 72.8 |
| Vitamin D3 | mg | 8.8 |
| Choline Chloride | g | 32.4 |
| L-Carnitine | g | 2.31 |
| Potassium Citrate | g | 1.86 |
| Riboflavin | mg | 838 |
| Vitamin A | mg | 540 |
| Thiamine Hydrochloride | mg | 135 |
| Sodium Chloride | | as needed |

TABLE 3

| | | Second Infant |
|---|---|---|
| | Units | Formula 2 |
| Energy | Kcal/L | 643 |
| Ingredient Water | Kg | Q.S. |
| Lactose | Kg | 53.99 |
| Nonfat Milk | Kg | 19.33 |
| High Oleic Safflower Oil | Kg | 12.90 |
| Soy Oil | Kg | 10.37 |
| Coconut Oil | Kg | 9.141 |
| Galacto-oligosaccharides | Kg | 8.630 |
| Whey Protein Concentrate | Kg | 8.440 |
| 1N KOH | Kg | 4.060 |
| Potassium Hydroxide | g | 203.0 |
| Ascorbic Acid | g | 727.5 |
| Calcium Carbonate | g | 545.1 |
| Potassium Citrate | g | 530.3 |
| Soy Lecithin | g | 508.4 |
| Distilled monoglycerides | g | 508.4 |
| ARA Oil | g | 359.3 |
| Potassium Chloride | g | 302.3 |
| Nucleotide-Choline Premix | g | 293.2 |
| Choline Bitartrate | g | 51.75 |
| Cytidine 5′-Monophosphate | g | 30.49 |
| Disodium Guanosine 5′-Monophosphate | g | 15.64 |
| Disodium Uridine 5′-Monophosphate | g | 13.15 |
| Adenosine 5′-Monophosphate | g | 11.60 |
| Magnesium Chloride | g | 194.5 |
| Carrageenan | g | 175.0 |
| Vit/Min/Taur Premix | g | 149.9 |
| Taurine | g | 45.83 |
| m-Inositol | g | 33.28 |
| Zinc Sulfate | g | 15.35 |
| Niacinamide | g | 9.781 |
| Calcium Pantothenate | g | 5.865 |
| Ferrous Sulfate | g | 5.131 |
| Cupric Sulfate | g | 1.800 |
| Thiamine Chloride HCl | g | 1.518 |
| Riboflavin | mg | 669.3 |
| Pyridoxine HCl | mg | 613.1 |
| Folic Acid | mg | 206.1 |
| Manganese Sulfate | mg | 174.6 |
| Biotin | mg | 59.21 |
| Sodium Selenate | mg | 35.51 |
| Cyanocobalamin | mg | 4.722 |
| Ultra-Micronized Tricalcium Phosphate | g | 154.0 |
| Potassium Phosphate Monobasic | g | 135.1 |
| DHA Oil | g | 131.0 |
| Vitamin A, D3, E, K1 | g | 69.36 |
| RRR Alpha-Tocopheryl Acetate | g | 8.986 |
| Vitamin A Palmitate | g | 1.783 |
| Vitamin K1 (Phylloquinone) | mg | 99.50 |
| Vitamin D3 | mg | 13.87 |
| Choline Chloride | g | 65.41 |
| Ferrous Sulfate | g | 60.91 |
| Carotenoid Premix | g | 57.14 |
| Lutein | mg | 120.0 |
| Lycopene | mg | 119.0 |
| Beta-Carotene | mg | 26.17 |
| Citric Acid (Processing Aid) | g | 29.80 |
| L-Carnitine | g | 3.616 |
| Riboflavin | g | 1.166 |
| Sodium Chloride | mg | 277 |

The formulas were prepared by making at least two separate slurries that were later blended together, heat treated, standardized, and terminally sterilized. Initially, a carbohydrate-mineral slurry was prepared by dissolving the selected carbohydrates (e.g., lactose, galactooligosaccharides) in water at 74-79° C., followed by the addition of citric acid, magnesium chloride, potassium chloride, potassium citrate, choline chloride, and sodium chloride. The resulting slurry was held under moderate agitation at 49-60° C. until it was later blended with the other prepared slurries.

A protein-in-fat slurry was prepared by combining the high oleic safflower oil, coconut oil, monoglycerides, and soy lecithin under agitation and heating to 66-79° C. Following a 10-15 minute hold time, soybean oil, oil soluble vitamin premix, mixed carotenoid premix, carrageenan, vitamin A, calcium citrate, dicalcium phosphate, ARA oil, DHA oil, and whey protein concentrate were then added to the slurry. The resulting oil slurry was held under moderate agitation at 49-60° C. until it was later blended with the other prepared slurries.

Water was heated to 49-60° C. and then combined with the carbohydrate-mineral slurry, nonfat milk, and the protein-in-fat slurry under adequate agitation. The pH of the resulting blend was adjusted with potassium hydroxide. This blend was held under moderate agitation at 49-60° C.

The resulting blend was heated to 74-79° C., emulsified through a single stage homogenizer to 900-1100 psig, and then heated to 144-147° C., for about 5 seconds. The heated blend was passed through a flash cooler to reduce the temperature to 88-93° C. and then through a plate cooler to further reduce the temperature to 74-85° C. The cooled blend was then homogenized at 2900-3100/400-600 psig, held at 74-85° C. for 16 seconds, and then cooled to 2-7° C. Samples were taken for analytical testing. The mixture was held under agitation at 2-7° C.

A water-soluble vitamin (WSV) solution and an ascorbic acid solution were prepared separately and added to the processed blended slurry. The vitamin solution was prepared by adding the following ingredients to water with agitation: potassium citrate, ferrous sulfate, WSV premix, L-carnitine, copper sulfate, riboflavin, inositol, and the nucleotide-choline premix. The ascorbic acid solution was prepared by adding potassium hydroxide and ascorbic acid to a sufficient amount of water to dissolve the ingredients. The ascorbic acid solution pH was then adjusted to 5-9 with potassium hydroxide.

The blend pH was adjusted to a specified pH range of 7.1-7.6 with potassium hydroxide (varied by product) to achieve optimal product stability. The completed product was then filled into suitable containers and thermally sterilized.

1. A method of reducing obesity later in life, the method comprising administering to an infant in need thereof during the first two weeks of life a first infant formula followed by a second infant formula, the first infant formula having a higher whey to casein protein weight ratio than the second infant formula, wherein each of the first and second infant formulas has an energy content of less than 650 Kcal/L.

2. The method of claim 1, wherein the first infant formula is administered to the infant for a period of 1 day to 10 days and the second infant formula is administered to the infant for a period of 4 to 13 days, wherein the first infant formula and the second infant formula are administered for a total of no more than 14 days.

3. The method of claim 1, wherein at least one of the first infant formula and the second infant formula has a protein content of less than 14.0 grams of protein per liter of formula.

4. The method according to claim 1, wherein at least one of the first infant formula and the second infant formula has an energy content of from 200 kcal/L to 600 kcal/L.

5. The method according to claim 1, wherein the first infant formula has a whey to casein protein weight ratio of 90:10, and the second infant formula has a whey to casein protein weight ratio of 60:40.

6. A method of reducing inflammatory-related diseases later in life, the method comprising administering to an infant in need thereof during the first two weeks of life a first infant formula followed by a second infant formula, the first infant formula having a higher whey to casein protein weight ratio than the second infant formula, wherein each of the first and second infant formulas has an energy content of less than 650 Kcal/L.

7. The method of claim 6, wherein the first infant formula is administered to the infant for a period of 1 day to 10 days and the second infant formula is administered to the infant for a period of 4 to 13 days, wherein the first infant formula and the second infant formula are administered for a total of no more than 14 days.

8. The method of claim 6, wherein at least one of the first infant formula and the second infant formula has a protein content of less than 14.0 grams of protein per liter of formula.

9. The method according to claim 6, wherein at least one of the first infant formula and the second infant formula has an energy content of from 200 kcal/L to 600 kcal/L.

10. The method according to claim 6, wherein the first infant formula has a whey to casein protein weight ratio of 90:10, and the second infant formula has a whey to casein protein weight ratio of 60:40.

11. A nutrition system comprising a first infant formula and a second infant formula, the first infant formula having a higher whey to casein protein weight ratio than the second infant formula, and wherein each of the first and second infant formulas has an energy content of less than 600 Kcal/L.

12. The nutrition system of claim 11, wherein at least one of the first infant formula and the second infant formula has a protein content of less than 14.0 grams of protein per liter of formula.

13. The nutrition system according to claim 11, wherein at least one of the first infant formula and the second infant formula has an energy content of from 200 kcal/L to 600 kcal/L.

14. The nutrition system according to claim 11, wherein the first infant formula has a whey to casein protein weight ratio of 90:10, and the second infant formula has a whey to casein protein weight ratio of 60:40.

15. (canceled)

16. The method of claim 3, wherein at least one of the first infant formula and the second infant formula has a protein content between 5.0 grams and 10.0 grams per liter of formula.

17. The method of claim 4, wherein at least one of the first infant formula and the second infant formula has an energy content of from 250 kcal/L to 500 kcal/L.

18. The method of claim 6, wherein the diseases are selected from the group consisting of insulin resistance, non-insulin dependent diabetes mellitus, cardiovascular disease, and atherosclerosis.

19. The method of claim 8, wherein at least one of the first infant formula and the second infant formula has a protein content between 5.0 grams and 10.0 grams per liter of formula.

20. The method of claim 9, wherein at least one of the first infant formula and the second infant formula has an energy content of from 250 kcal/L to 500 kcal/L.

21. The nutrition system of claim 12, wherein at least one of the first infant formula and the second infant formula has a protein content between 5.0 grams and 10.0 grams per liter of formula.

22. The nutrition system of claim 13, wherein at least one of the first infant formula and the second infant formula has an energy content of from 250 kcal/L to 500 kcal/L.
